(19) United States
(12) Patent Application Publication
(10) Pub. No.: US 2017/0328460 A1
(43) Pub. Date: Nov. 16, 2017

(54) Limited Slip Differential Having Cam Integrated Into Rotatable Cross-Shaft Carrier

(71) Applicant: American Axle & Manufacturing, Inc., Detroit, MI (US)

(72) Inventor: Michael Schulte, Sylvania, OH (US)

(21) Appl. No.: 15/496,004

(22) Filed: Apr. 25, 2017

Related U.S. Application Data
(60) Provisional application No. 62/334,590, filed on May 11, 2016.

(51) Int. Cl. F16H 48/22; F16D 23/12; F16H 48/08; F16D 13/52

(52) U.S. Cl. CPC F16H 48/22; F16H 48/08; F16D 13/52; F16D 23/12; F16D 2023/123

(57) ABSTRACT

A limited slip differential having a differential gearset and a cam-type limited slip mechanism. The differential gearset has a plurality of differential pinions that are journally supported by a cross-shaft. The cross-shaft is supported by a rotatable cross-shaft carrier. The limited slip mechanism includes a clutch pack, a pressure ring, a plurality of first cams, which are coupled to the cross-shaft carrier for rotation therewith, and a plurality of second cams that are coupled to the pressure ring. The first cams cooperate with the second cams to convert rotation of the cross-shaft carrier to translation of the pressure ring to thereby control engagement of the clutch pack.

### CROSS-REFERENCE TO RELATED APPLICATIONS

This application claims the benefit of U.S. Provisional Patent Application No. 62/334,590 filed May 11, 2016, the disclosure of which is incorporated by reference as if fully set forth in detail herein.

### FIELD

The present disclosure relates to a limited slip differential and more particularly to a limited slip differential having a cam that is integrated into a rotatable cross-shaft carrier.

### BACKGROUND

This section provides background information related to the present disclosure which is not necessarily prior art.

Limited slip differentials are employed in automotive vehicles to limit speed differentiation between the two outputs of the differential under certain circumstances. One type of limited slip differential employs one or more clutch packs having two sets of friction plates: a first set that is non-rotatably coupled to a differential case and a second one that is non-rotatably coupled to a side gear of a differential gearset that is disposed in the differential case. Frictional engagement of the friction plates in the clutch pack(s) frictionally couples the side gear(s) to the differential case, thereby tending to reduce or eliminate the speed differential between the two side gears.

One technique for energizing the clutch pack(s) in this type of limited slip differential employs relative motion of a cross-shaft that journally supports a pair of (bevel) pinon gears that meshingly engage the (bevel) side gears. Under relatively light loading, the cross-shaft of a limited slip differential of this type is maintained in a stationary position relative to the differential case by a pair of thrust members that are non-rotatably coupled to the differential case. When the limited slip differential of this configuration is heavily loaded, however, the cross-shaft tends to rotate somewhat about the rotational axis of the differential case so that cam surfaces on the cross-shaft and the thrust members interact to cause the thrust members to shift outwardly from the cross-shaft along the rotational axis of the differential case to thereby compress (and frictionally engage) the clutch packs.

One drawback associated with this type of limited slip differential concerns the support for the cross-shaft. In this regard, the cross-shaft of the aforementioned type of limited slip differential tends to be supported to a lesser degree when the limited slip differential is heavily loaded. Moreover, while the degree of freedom between the cross-shaft and the thrust members/differential case may be acceptable in certain situations, we note that it can be problematic when three or more differential pinions are employed.

### SUMMARY

This section provides a general summary of the disclosure, and is not a comprehensive disclosure of its full scope or all of its features.

In one form, the present disclosure provides a limited slip differential having a differential case, a cross-shaft carrier, a differential gearset, a pressure ring and a clutch pack. The differential case has a cavity formed therein and is rotatable about an axis. The cross-shaft carrier, which is received in the cavity and moveable about the axis relative to the differential case, has a wall member and a plurality of first cams. The differential gearset has first and second side gears, a plurality of pinion gears and a cross-shaft. The first and second side gears are received in the differential cavity and disposed along the axis such that the cross-shaft carrier is disposed between the first and second side gears. Each of the pinion gears is meshingly engaged to the first and second side gears and journally supported on the cross-shaft. The cross-shaft is coupled to the wall member in a manner that inhibits rotation of the cross-shaft about the axis relative to the cross-shaft carrier. The pressure ring has a plurality of second cams and is non-rotatably but axially slidably coupled to the differential case. The clutch pack is disposed between the differential case and the pressure ring. The clutch pack has one or more first clutch plates, which are non-rotatably coupled to the differential case, and one or more second clutch plates that are non-rotatably coupled to the first side gear. Each of the second clutch plates is disposed adjacent an associated one of the first clutch plates. The first and second cams cooperate to coordinate rotational motion of the cross-shaft carrier relative to the differential case with movement of the pressure ring along the axis.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective, partly broken-away illustration of an exemplary driveline component having a limited slip differential constructed in accordance with the teachings of the present disclosure;

FIG. 2 is a front elevation view of the limited slip differential of FIG. 1;

FIG. 3 is a section view taken along the line 3-3 of FIG. 2;

FIG. 4 is an exploded perspective view of the limited slip differential of FIG. 1; and

FIG. 5 is a perspective view of a portion of the limited slip differential of FIG. 1.

Corresponding reference numerals indicate corresponding parts throughout the several views of the drawings.

### DETAILED DESCRIPTION

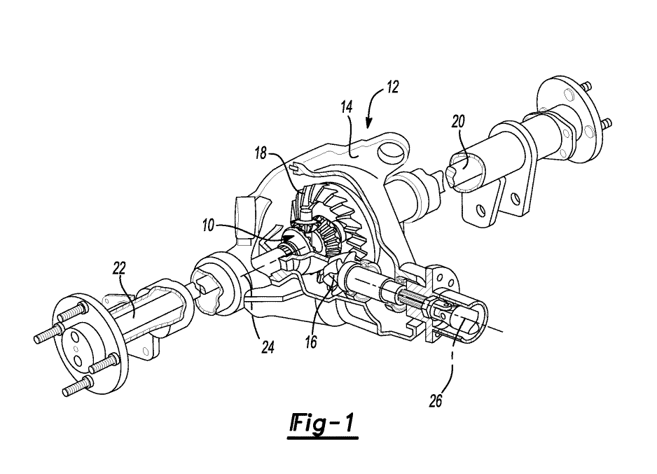

With reference to FIG. 1, an exemplary limited slip differential 10 constructed in accordance with the teachings of the present disclosure is operatively illustrated in a driveline component. In the example provided, the driveline component is an axle assembly 12, but it will be appreciated that the limited slip differential 10 could be employed in various other driveline components, such as a transaxle, a transfer case, or a center differential assembly. The axle assembly 12 can include a housing 14, an input pinion 16, a ring gear 18 and first and second axle shafts 20 and 22, respectively. The limited slip differential 10 can be received in the housing 14 and can be rotatable about an axis 24. The input pinion 16 can be received in the housing 14 and can be rotatable about another axis 26 that can be generally transverse to the axis 24 of the limited slip differential 10. The ring gear 18 can be received in the housing 14 and can be fixedly coupled to a portion of the limited slip differential 10 (i.e., to a differential case) for rotation therewith. The ring gear 18 can mesh with the input pinion 16 to receive rotary power therefrom. In the particular example provided, the ring gear 18 is a type of bevel ring gear, such as a hypoid spiral bevel gear, but it will be appreciated that the ring gear 18 could be an annular (e.g., helical) gear, for example when the limited slip differential 10 is employed in a transaxle. Each of the first and second axle shafts 20 and 22 can be drivingly coupled to an associated output of the limited slip differential 10 (i.e., to first and second side gears, respectively).

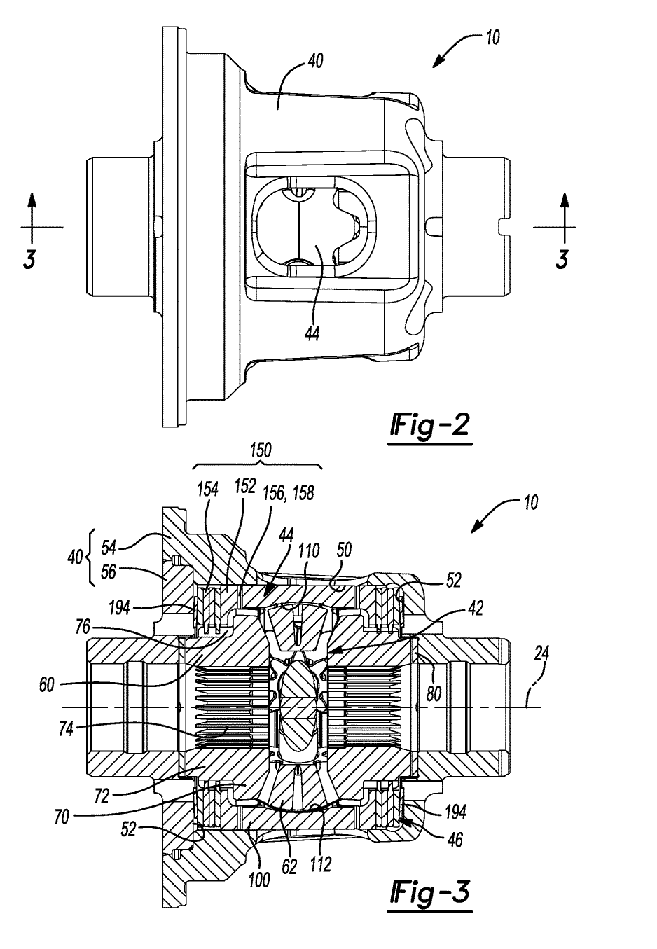

With reference to FIGS. 2 and 3, the limited slip differential 10 is illustrated in more detail. The limited slip differential 10 can include a differential case 40, a differential gearset 42, a support means 44, and a limited slip mechanism 46.

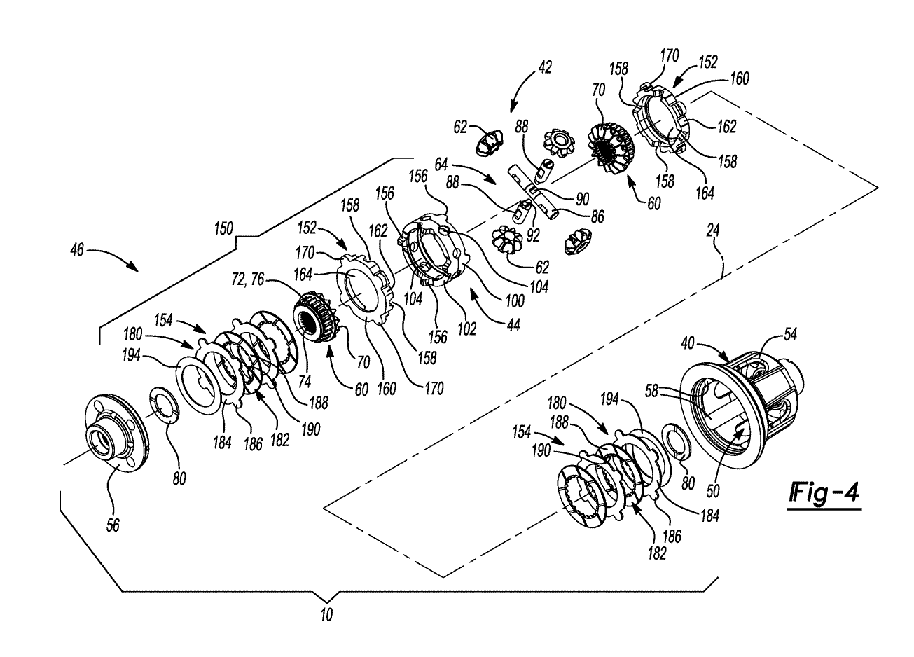

With reference to FIGS. 3 and 4, the differential case 40 is rotatable about the axis 24 and defines a differential cavity 50 that terminates at opposite internal end walls 52. In the particular example provided, the differential case 40 is formed of two components, a case member 54 and a cap member 56, that are fixedly coupled to one another, such as through welds or threaded fasteners, but it will be appreciated that the differential case 40 could be unitarily formed or could be formed from more than two discrete components. The differential case 40 can define a plurality of spline grooves 58 that can intersect the differential cavity 50. The spline grooves 58 can extend parallel to the axis 24 and can be spaced circumferentially apart from one another. In the particular example provided, the spline grooves 58 number four in quantity and have a generally square profile, but it will be appreciated that the quantity of the spline grooves could be different and/or the shape of the spline grooves could be configured differently.

The differential gearset 42 can be received into the differential cavity 50 and can have a pair of side gears 60, a plurality of differential pinions 62 and a cross-shaft 64. The side gears 60 can have a gear portion 70, a body portion 72, which can extend from the gear portion 70, and an internally splined aperture 74. The gear portion 70 has gear teeth that can be configured in any desired manner, for example as bevel gear teeth. The body portion 72 can extend from the gear portion 70 and can define a plurality of external spline teeth 76. The internal spline teeth 74 can be formed through the gear portion 70 and the body portion 72 and are configured to be engaged by external splines (not shown) on a corresponding one of the first and second axle shafts 20 and 22 (FIG. 1). Optionally, a thrust washer 80 can be disposed between an axial end of the body portion 72 of each of the side gears 60 and the differential case 40. In the example provided, each of the differential pinions 62 is a bevel pinion that is meshingly engaged with both of the side gears 60. The cross-shaft 64 is configured to journally support the differential pinions 62. In the example provided, the differential pinions 62 number four in quantity and as such, the cross-shaft 64 includes four shaft sections, each of which being configured to journally support a corresponding one of the differential pinions 62. The shaft sections can be configured in any desired manner. In the illustrated embodiment, two of the shaft sections are formed in an integral and unitary manner to thereby form a relatively long pin 86, while the two remaining shaft sections are formed as relatively short pins 88 that can be coupled to the long pin 86 in any desired manner. For example, the long pin 86 can be formed with apertures 90 (only one shown) that can be sized to receive a projection 92 formed on an associated one of the short pins 88.

The support means 44 is received into the differential cavity 50 and is configured to support the cross-shaft 64 for rotation about the axis 24 relative to the differential case 40. The support means 44 can be a cross-shaft carrier 100 having an annular wall member 102 through which a plurality of cross-shaft apertures 104 can be formed. The cross-shaft apertures 104 are sized to receive associated portions of the cross-shaft 64 therethrough. In the example provided, a pair of the cross-shaft apertures 104 are sized to receive the long pin 86 therein, while a pair of the remaining cross-shaft apertures 104 are each sized to receive a corresponding one of the short pins 88 therein. Additional holes are shown through the annular wall member 102 of the cross-shaft carrier 100 as a means for reducing the mass of the cross-shaft carrier 100. The cross-shaft carrier 100 can define a plurality of pinion thrust surfaces 110 against which the differential pinions 62 are configured to thrust against when the differential gearset 42 is loaded. In the example provided, the pinion thrust surfaces 110 have a spherical shape and the differential pinions 62 have a correspondingly shaped thrust surface 112.

The limited slip mechanism 46 can include one or more clutch sets 150, each of which comprising a pressure ring 152, a clutch pack 154, a plurality of first cams 156, and a plurality of second cams 158. The pressure ring 152 can have an annular wall 160 and a circumferentially extending wall 162 that can be fixedly coupled to a radially outer side of the annular wall 160. A hole 164 defined by the annular wall 160 can be sized to receive the body portion 72 of a corresponding one of the side gears 60 therethrough, while the circumferentially extending wall 162 can be sized larger in diameter than the gear portion 70 of the corresponding one of the side gears 60. The circumferentially extending wall 162 can define a plurality of lugs 170, each of which being received into a corresponding one of the spline grooves 58 that are formed in the differential case 40. It will be appreciated that engagement of the lugs 170 with the spline grooves 58 inhibits rotation of the pressure ring 152 relative to the differential case 40 but permits movement of the pressure ring 152 along the axis 24 relative to the differential case 40.

The clutch pack 154 can include one or more first clutch plates 180 and one or more second clutch plates 182. The first clutch plates 180 can have an annular plate body 184, which is configured to receive the body portion 72 of the corresponding one of the side gears 60 therethrough and a plurality of tabs 186 that extend from the annular plate body 184. The tabs 186 are received into the spline grooves 58 in the differential case 40 to thereby couple the first clutch plate(s) 180 to the differential case 40 in a manner that inhibits relative rotation while permitting movement of the first clutch plate(s) 180 along the axis 24 relative to the differential case 40. The second clutch plate(s) 182 can have an annular plate body 188 having a plurality of internal spline teeth 190 that are engaged to the external spline teeth 76 on the body portion 72 of the corresponding one of the side gears 60 so that the second clutch plate(s) 182 are non-rotatably but axially slidably coupled to the corresponding one of the side gears 60. Each of the second clutch plate(s) 182 can be disposed adjacent to one or more of the first clutch plate(s) 180 and vice versa. In the particular example provided, each of the clutch packs 154 is identically configured and employs a quantity of two of the first clutch plates 180 and two of the second clutch plates 182. It will be appreciated that different quantities of the first clutch plates 180 and/or the second clutch plates 182 could be employed in the alternative from that which is described herein and depicted in the drawings, and that if desired, the clutch packs 154 could be configured differently from one another.

Optionally, a spring 194 can be disposed between the clutch pack 154 and the differential case 40. The spring 194 can be employed to pre-load the clutch pack 154 and/or to limit the force that is applied to the clutch pack 154 to frictionally engage the first and second clutch plates 180 and 182 with one another. In the example provided, the spring 194 is a Belleville spring washer.

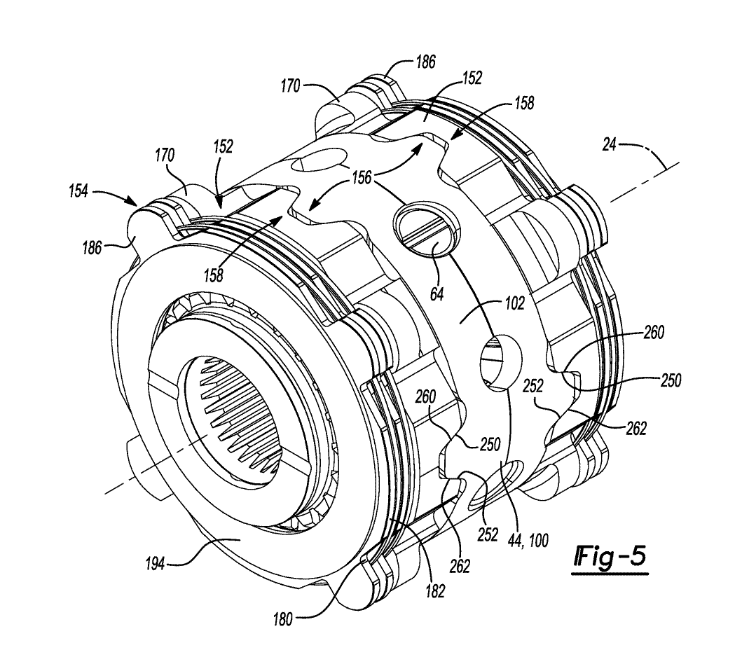

With reference to FIG. 5, the first and second cams 156 and 158 can be configured to cooperate to convert rotational movement of the support means 44/cross-shaft 64 into movement of the pressure ring 152 along the axis 24. Each of the first cams 156 can be fixedly coupled to the annular wall member 102 of the cross-shaft carrier 100, while each of the second cams 158 can be fixedly coupled to the pressure ring 152. In the example provided, each of the first cams 156 comprise a projection that extends axially from the annular wall member 102 of the cross-shaft carrier 100 and defines first and second cam surfaces 250 and 252, respectively, while each of the second cams 158 comprise a notch that is formed in an axial end of the circumferentially extending wall 162 of the pressure ring 152 and defines third and fourth cam surfaces 260 and 262, respectively. Each first cam 156 can be engaged to a corresponding one of the second cams 158 such that the first and second cam surfaces 250 and 252 engage the third and fourth cam surfaces 260 and 262, respectively, to thereby locate the support means 44 and the cross-shaft 64 in corresponding neutral (rotational) positions relative to the differential case 40.

Rotation of the support means 44 about the axis 24 relative to the differential case 40 in a first rotational direction can drive the support means 44 and the cross-shaft 64 out of their neutral positions so that the second and fourth cam surfaces 252 and 262 disengage one another while the first and third cam surfaces 250 and 260 remain in engagement with one another. It will be appreciated that the point at which the first and third cam surfaces 250 and 260 contact one another will vary or move as the support means 44 rotates about the axis 24 relative to the pressure ring 152 in the first rotational direction. Due to the shaping of the first and third cam surfaces 250 and 252 and the confinement of the support means 44 between two pressure rings 152, rotation of the support means 44 about the axis 24 in the first rotational direction causes movement of the pressure ring 152 along the axis 24 in a direction away from the support means 44, which causes the pressure ring 152 to drive the first and second clutch plates 180 and 182 into frictional engagement with one another.

Rotation of the support means 44 about the axis 24 relative to the differential case 40 in a second rotational direction opposite the first rotational direction can drive the support means 44 and the cross-shaft 64 out of their neutral positions so that the first and third cam surfaces 250 and 260 disengage one another while the second and fourth cam surfaces 252 and 262 remain in engagement with one another. It will be appreciated that the point at which the second and fourth cam surfaces 252 and 262 contact one another will vary or move as the support means 44 rotates about the axis 24 relative to the pressure ring 152 in the second rotational direction. Due to the shaping of the second and fourth cam surfaces 252 and 262 and the confinement of the support means 44 between two pressure rings 152, rotation of the support means 44 about the axis 24 in the second rotational direction causes movement of the pressure ring 152 along the axis 24 in a direction away from the support means 44, which causes the pressure ring 152 to drive the first and second clutch plates 180 and 182 into frictional engagement with one another.

In some embodiments, the first and second cam surfaces 250 and 252 can be configured in an identical manner and the third and fourth cam surfaces 260 and 262 can be configured in an identical manner. In other embodiments, the first and second cam surfaces 250 and 252 can be configured differently from one another, and/or the third and fourth cam surfaces 260 and 262 can be configured differently from one another. It will be appreciated that configuration of a set of the cam surfaces (i.e., the first and second cam surfaces 250 and 252 and/or the third and fourth cam surfaces 260 and 262) in a manner that is different from one another provides the first cam 156 and/or the second cam 158 with a non-symmetrical configuration (i.e., non-symmetrical about the neutral position of the support means 44) that is employed to coordinate rotation of the support means 44 about the axis 24 in the first rotational direction from the neutral position with translation of the pressure ring 152 along the axis 24 in a first manner, and to coordinate rotation of the support means 44 about the axis in the second rotational direction from the neutral position with translation of the pressure ring 152 along the axis 24 in a second manner. Consequently, rotation of the support means 44 about the axis 24 relative to the differential case 40 through a predetermined angle in the first rotational direction from the neutral position can move the pressure ring 152 away from the support means 44 in the first manner, and rotation of the support means 44 about the axis 24 relative to the differential case 40 through the predetermined angle in the second rotational direction from the neutral position moves the first and second pressure ring 152 and—away from the support means 44 in the second manner. The first and second manners can differ in the rate at which the pressure ring 152 travel along the axis 24 per unit of rotation of the cross-shaft carrier 100 relative to the differential case 40. Additionally or alternatively, the first and second manners can differ in a magnitude of permitted translation of the pressure ring 152 along the axis 24 in a direction away from the support means 44.

The support means 44 is advantageous in that it maintains the cross-shaft 64 perpendicular to the axis 24 regardless of the degree to which the cross-shaft 64 has rotated about the axis 24 relative to the differential case 40 from the neutral position. Moreover, the support means 44 provides a surface (i.e., the inside diametrical surface of the cross-shaft carrier 100) that the differential pinions 62 thrust against so that contact between the surface and the differential pinions 62 does not change regardless of the position of the cross-shaft carrier 100 relative to the differential case 40. As such, it will be appreciated that a limited slip differential constructed in accordance with the teachings of the present disclosure is more resistant to wear as compared to a conventionally constructed cam-type limited slip differential.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A limited slip differential comprising:
a differential case having a differential cavity formed therein, the differential case being rotatable about an axis;
a cross-shaft carrier received in the differential cavity and being moveable about the axis relative to the differential case, the cross-shaft carrier having a wall member and a plurality of first cams;
a differential gearset having first and second side gears, a plurality of pinion gears and a cross-shaft, the first and second side gears being received in the differential cavity and disposed along the axis such that the cross-shaft carrier is disposed between the first and second side gears, each of the pinion gears being meshingly engaged to the first and second side gears and journally supported on the cross-shaft, the cross-shaft being coupled to the wall member in a manner that inhibits rotation of the cross-shaft about the axis relative to the cross-shaft carrier;
a first pressure ring that is non-rotatably coupled to the differential case, the first pressure ring being slidable relative to the differential case along the axis, the first pressure ring having a plurality of second cams; and
a first clutch pack disposed between the differential case and the first pressure ring, the first clutch pack having one or more first clutch plates, which are non-rotatably coupled to the differential case, and one or more second clutch plates that are non-rotatably coupled to the first side gear, each of the second clutch plates being disposed adjacent an associated one of the first clutch plates;
wherein the first and second cams cooperate to coordinate rotational motion of the cross-shaft carrier relative to the differential case with movement of the first pressure ring along the axis.

2. The limited slip differential of claim 1, wherein the cross-shaft carrier includes a plurality of third cams and wherein the limited slip differential further comprises:
a second pressure ring that is non-rotatably coupled to the differential case, the second pressure ring being slidable relative to the differential case along the axis and having a plurality of fourth cams; and
a second clutch pack disposed between the differential case and the second pressure ring, the second clutch pack having one or more third clutch plates, which are non-rotatably coupled to the differential case, and one or more fourth clutch plates that are non-rotatably coupled to the second side gear, each of the fourth clutch plates being disposed adjacent an associated one of the third clutch plates;
wherein the third and fourth cams cooperate to coordinate rotational motion of the cross-shaft carrier relative to the differential case with movement of the second pressure ring along the axis.

3. The limited slip differential of claim 2, wherein each of the third cams, each of the fourth cams, or each of the third and fourth cams is configured in a non-symmetrical manner such that rotation of the cross-shaft carrier relative to the differential case through a predetermined angle in a first rotational direction from a neutral position moves the second pressure ring away from the cross-shaft carrier in a first manner, and rotation of the cross-shaft carrier relative to the differential case through the predetermined angle in a second, opposite rotational direction from the neutral position moves the second pressure ring away from the cross-shaft carrier in a second manner.

4. The limited slip differential of claim 3, wherein the first and second manners differ in a rate at which the second pressure ring travels along the axis per unit of rotation of the cross-shaft carrier relative to the differential case.

5. The limited slip differential of claim 2, further comprising a preload spring disposed between the second clutch pack and the differential case.

6. The limited slip differential of claim 2, wherein a quantity of the fourth clutch plates is equal in number to a quantity of the second clutch plates.

7. The limited slip differential of claim 1, wherein the cross-shaft comprises a first pin, a second pin and a third pin, the second and third pins being shorter than the first pin.

8. The limited slip differential of claim 7, wherein the second and third pins are supported on the first pin.

9. The limited slip differential of claim 1, wherein each of the first cams, each of the second cams, or each of the second and third cams is configured in a non-symmetrical manner such that rotation of the cross-shaft carrier relative to the differential case through a predetermined angle in a first rotational direction from a neutral position moves the first pressure ring away from the cross-shaft carrier in a first manner, and rotation of the cross-shaft carrier relative to the differential case through the predetermined angle in a second, opposite rotational direction from the neutral position moves the first pressure ring away from the cross-shaft carrier in a second manner.

10. The limited slip differential of claim 9, wherein the first and second manners differ in a rate at which the first pressure ring travels along the axis per unit of rotation of the cross-shaft carrier relative to the differential case.

11. The limited slip differential of claim 1, further comprising a preload spring disposed between the first clutch pack and the differential case.

12. The limited slip differential of claim 1, further comprising:
a housing into which the differential case is rotatably supported;
an input pinion rotatably disposed in the housing;
a ring gear meshed with the input pinion, the ring gear being fixedly coupled to the differential case; and
first and second axle shafts, the first axle shaft being driven by the first side gear, the second axle shaft being driven by the second side gear.

13. The limited slip differential of claim 1, further comprising:
a housing into which the limited slip differential is rotatably received;
an annular gear coupled to the differential case for rotation therewith; and
an input gear meshingly engaged with the annular gear.

14. The limited slip differential of claim 13, wherein the annular gear is a bevel ring gear.

15. A limited slip differential comprising:
a differential case having a differential cavity formed therein, the differential case being rotatable about an axis;
a differential gearset having first and second side gears, a plurality of pinion gears and a cross-shaft, the first and second side gears being received in the differential cavity, each of the pinion gears being meshingly engaged to the first and second side gears and journally supported on the cross-shaft;
means for supporting the cross-shaft for rotation relative to the differential case about the axis; and
means for frictionally engaging at least one of the first and second side gears to the differential case, the friction engaging means being responsive to relative rotation between the cross-shaft supporting means and the differential case.

16. The limited slip differential of claim 15, wherein the friction engaging means comprises a first cam, which is non-rotatably coupled to the cross-shaft supporting means, a pressure ring, which is non-rotatably coupled to the differential case, and a second cam that is non-rotatably coupled to the pressure ring and engaged to the first cam.

17. The limited slip differential of claim 16, wherein the friction engaging means further comprises a clutch pack disposed along the axis between the pressure ring and the differential case, the clutch pack having one or more first clutch plates, which are non-rotatably but axially slidably coupled to the differential case, and one or more second clutch plates that non-rotatably but axially slidably coupled to one of the first and second side gears, wherein each of the second clutch plates is disposed adjacent to an associated one of the first clutch plates.

18. The limited slip differential of claim 17, further comprising a spring received in the differential case and preloading the clutch pack.

19. The limited slip differential of claim 15, wherein the friction engaging means is configured such that rotation of the cross-shaft relative to the differential case about the axis in a first rotational direction by a predetermined angle from a neutral position produces frictional engagement between the at least one of the first and second side gears and the differential case of a first magnitude, and rotation of the cross-shaft relative to the differential case about the axis in a second, opposite rotational direction by the predetermined angle from the neutral position produces frictional engagement between the at least one of the first and second side gears and the differential case of a second magnitude that is different from the first magnitude.

20. The limited slip differential of claim 15, wherein the cross-shaft comprises a first pin, a second pin and a third pin, the second and third pins being shorter than the first pin.

21. The limited slip differential of claim 20, wherein the second and third pins are supported on the first pin.

22. The limited slip differential of claim 15, further comprising:
a housing into which the limited slip differential is rotatably received;
an annular gear coupled to the differential case for rotation therewith; and
an input gear meshingly engaged with the annular gear.
